(19) United States
(12) Patent Application Publication
(10) Pub. No.: US 2024/0008079 A1
(43) Pub. Date: Jan. 4, 2024

(54) CONGESTION CONTROL FOR SIDELINK COMMUNICATION

(71) Applicant: QUALCOMM Incorporated, San Diego, CA (US)

(72) Inventors: Shuanshuan WU, San Diego, CA (US); Xiaoxia ZHANG, San Diego, CA (US); Shailesh PATIL, San Diego, CA (US); Jing SUN, San Diego, CA (US); Stelios STEFANATOS, San Diego, CA (US); Arthur GUBESKYS, San Diego, CA (US); Parisa CHERAGHI, Cambridge (GB); Gene Wesley MARSH, San Diego, CA (US)

(21) Appl. No.: 18/036,138

(22) PCT Filed: Dec. 17, 2021
(86) PCT No.: PCT/US2021/073014

§ 371 Date: May 9, 2023

(30) Foreign Application Priority Data
Jan. 7, 2021 (GR) 20210100009

(51) Int. Cl. H04W 74/08; H04W 72/25; H04B 17/318

(52) U.S. Cl. CPC H04W 74/0816; H04W 72/25; H04B 17/328

(57) ABSTRACT

In an aspect, the present disclosure includes a method and apparatus for sidelink communications for identifying at least one slot in a measurement window as a channel busy ratio (CBR) relevant slot, calculating a CBR based on at least a measurement in at least the CBR relevant slot, and transmitting, or refraining from transmitting, a sidelink transmission based at least on the CBR.

### CROSS-REFERENCE TO RELATED APPLICATION

This application is a 35 U.S.C. § 371 National Phase Application of PCT Application PCT/US2021/070314, filed Dec. 17, 2021, which claims priority to Greek Patent Application No. 20210100009, entitled “CONGESTION CONTROL FOR SIDELINK COMMUNICATION,” filed on Jan. 7, 2021, the disclosure of which is incorporated by reference herein in its entirety.

### TECHNICAL FIELD

The present disclosure relates generally to communication systems, and more particularly, to congestion control for sidelink communication, for instance in vehicle-to-everything (V2X), or other device-to-device (D2D) communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some wireless communication networks include device-to-device (D2D) communication such as, but not limited to, vehicle-based communication devices that can communicate from vehicle-to-vehicle (V2V), vehicle-to-infrastructure (V2I) (e.g., from the vehicle-based communication device to road infrastructure nodes), vehicle-to-network (V2N) (e.g., from the vehicle-based communication device to one or more network nodes, such as a base station), a combination thereof and/or with other devices, which can be collectively referred to as vehicle-to-anything (V2X) communications. Such systems may be deployed in shared spectrum environments which may include sharing of licensed spectrum and also unlicensed spectrum. Existing shared spectrum congestion control techniques may not be feasible for sidelink communication congestion control in unlicensed spectrum.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method of sidelink communication is provided. The method includes determining at least one slot in a measurement window as a channel busy ratio (CBR) relevant slot, calculating a CBR based on at least a measurement in at least the CBR relevant slot, and transmitting, or refraining from transmitting, a sidelink transmission based at least on the CBR.

Another example aspect includes an apparatus for sidelink communication, including a processor and a memory configured to store instructions, and one or more processors communicatively coupled with the memory, wherein the one or more processors are configured to identify at least one slot in a measurement window as a CBR relevant slot, calculate a CBR based on at least a measurement in at least the CBR relevant slot, and transmit, or refraining from transmitting, a sidelink transmission based at least on the CBR.

Another example implementation includes a non-statutory computer-readable medium storing instructions for sidelink communication, executable by a processor to store instructions, and one or more processors communicatively coupled with the memory, wherein the one or more processors are configured to identify at least one slot in a measurement window as a CBR relevant slot, calculate a CBR based on at least a measurement in at least the CBR relevant slot, and transmit, or refraining from transmitting, a sidelink transmission based at least on the CBR.

An apparatus for sidelink communication, comprising means for determining at least one slot in a measurement window as a channel busy ratio (CBR) relevant slot, means for calculating a CBR based on at least a measurement in at least the CBR relevant slot, and means for transmitting, or refraining from transmitting, a sidelink transmission based at least on the CBR.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first 5G/NR frame, in accordance with some aspects of the present disclosure.

FIG. 2B is a diagram illustrating an example of DL channels within a 5G/NR subframe, in accordance with some aspects of the present disclosure.

FIG. 2C is a diagram illustrating an example of a second 5G/NR frame, in accordance with some aspects of the present disclosure.

FIG. 2D is a diagram illustrating an example of UL channels within a 5G/NR subframe, in accordance with some aspects of the present disclosure.

FIG. 3 is an example diagram illustrating a frame structure and resources for sidelink communications, in accordance with various aspects of the present disclosure.

FIG. 4 is a diagram illustrating an example of a base station and user equipment (UE) in an access network, in accordance with various aspects of the present disclosure.

FIG. 5 is diagram illustrating an example of a sidelink communication slot with gap and non-gap portions, in accordance with various aspects of the present disclosure.

FIG. 6 is a diagram illustrating an example of a CBR evaluation window, in accordance with various aspects of the present disclosure.

FIG. 7 is an example flowchart of a method of sidelink communication of a network entity performing a CBR evaluation in CBR relevant slots, in accordance with various aspects of the present disclosure.

FIG. 8 is another example flowchart for optional operations for the method in the example flowchart of FIG. 7.

FIG. 9 is a block diagram illustrating an example of a UE, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The current design of cellular sidelink communication systems, such as D2D and/or V2X communication systems, target deployment in licensed spectrum. For instance, these current designs for sidelink communication systems are configured for either sharing spectrum in a licensed cellular band (e.g., uplink spectrum), or in a dedicated ITS (intelligent transportation system) spectrum (e.g., around 5.9 GHz band). However, dedicated spectrum may be not guaranteed in some regions due to scarcity of spectrum. For example, in some areas or countries, there may be dedicated spectrum allocated for Long Term Evolution (LTE) V2X, but no spectrum available for New Radio (NR) V2X. Sidelink communication systems, including V2X communication systems, may have to be deployed in unlicensed spectrum, given that V2X may be the only option in some regions. However, unlicensed spectrum may be shared by other technologies like Wireless Fidelity (Wi-Fi). Further, access to a communication medium in unlicensed spectrum may be subject to regulatory requirements. For example, one of the requirements may be listen-before-talk (LBT), e.g., a device may transmit only if the channel is sensed to be free (e.g., energy measured in the channel is below a threshold, referred to as energy-detection based channel sensing).

Sidelink communication techniques such as V2X support an autonomous resource allocation mode, e.g., a user equipment (UE) may access a communication channel based on sensing, without relying on scheduling by a base station (BS). Further, V2X has congestion control that may be enabled in the autonomous resource allocation mode. For example, if the UE is configured with a higher layer parameter CR-Limit and transmits PSSCH in slot n, the UE ensures the following limits for any priority value k, Σ_{i≥k} CR(i)≤CR_{Limit}(k), where CR(i) is a channel occupancy ratio (CR) evaluated in slot n-N for Physical Sidelink Shared Channel (PSSCH) transmissions with a priority field in the Sidelink Control Information (SCI) set to i, and CR_{Limit}(k) corresponds to the high layer parameter CR-Limit that is associated with the priority value k and the CBR range which includes the CBR measured in slot n-N, where Nis the congestion control processing time. The congestion control processing time N may be based on numerology p (subcarrier spacing of sidelink) and a processing capability of the UE. The UE may only apply a single processing time capability in sidelink congestion control. For example, for the values of p being 0, 1, 2, 3, the corresponding values of N may be 2, 2, 4 and 8 slots, respectively. Similarly, for the values of p being 0, 1, 2, 3, the corresponding values of N may be 2, 4, 8 and 16 slots, respectively.

A Sidelink Channel Occupancy Ratio (SL CR) evaluated at slot n may be defined as the total number of sub-channels used for its transmissions in slots [n−a, n−1] and granted in slots [n, n+b] divided by the total number of configured sub-channels in the transmission pool over [n−a, n+b], where a may be a positive integer and b may be 0 or a positive integer; a and b are determined by the UE implementation with a+b+1=1000 or 1000×2^{μ} slots, according to higher layer parameter timeWindowSize-CR, b<(a+b+1)/2, and n+b may not exceed the last transmission opportunity of the grant for the current transmission. SL CR is evaluated for each transmission or re-transmission. In evaluating the SL CR, the UE may assume the transmission parameter used at slot n is reused according to the existing grant(s) in slot [n+1, n+b] without packet dropping. The slot index may be based on a physical slot index. Further, the SL CR may be computed per priority level. For example, SL CR may range from 0.0001 to 1.

A SL Channel Busy Ratio (SL CBR) measured in slot n is defined as the portion of sub-channels in the resource pool whose sidelink (SL) received signal strength indicator (RSSI) (SL RSSI) measured by the UE exceeds a pre-configured threshold sensed over a CBR measurement window [n−a, n−1], wherein a is equal to 100 or 100×2 slots, according to higher layer parameter timeWindowSize-CBR. The slot index may be based on a physical slot index. SL CBR may range from 0.01 to 1. SL RSSI may be defined as the linear average of the total received power (in Watts) observed in the configured sub-channel in OFDM symbols of a slot configured for PSCCH and PSSCH starting from the second OFDM symbol. For example, for frequency range 1, the reference point for the SL RSSI may be the antenna connector of the UE. In another example, for frequency range 2, the SL RSSI may be measured based on the combined signal from antenna elements corresponding to a given receiver branch. In another example, for frequency range 1 and 2, if receiver diversity is in use by the UE, the reported SL RSSI value may not be lower than the corresponding SL RSSI of any of the individual receiver branches.

The existing congestion control techniques for sidelink communication may not be applicable for implementing congestion control in unlicensed spectrum due to problems such as SL RSSI measurement being taken into account for Wi-Fi activities in a communication medium. As a result, CBR evaluated based on the SL RSSI measurement may no longer reflect V2X UE channel occupancy.

The improved congestion control techniques according to the present disclosure are useful for sidelink (including V2x) congestion control in unlicensed spectrum. In an aspect, the congestion control techniques described herein include excluding resource occupancy by other radio access technologies (RATs), such as but not limited to Wi-Fi transmissions, for congestion control. For sidelink data transmission, the UE may perform congestion control by determining CBR, but only in CBR relevant slots in a CBR measuring window. Based on the CBR, the UE may determine a CR limit. For instance, a different CBR value may be mapped to different CR limit. The UE may determine whether the total number of transmissions within a window would exceed the CR limit. If the UE determines that the total number of transmissions within the window would not exceed the CR limit, the UE may determine to transmit a sidelink transmission. If the UE determines that the total number of transmissions within the window would exceed the CR limit, the UE may determine not to transmit a sidelink transmission.

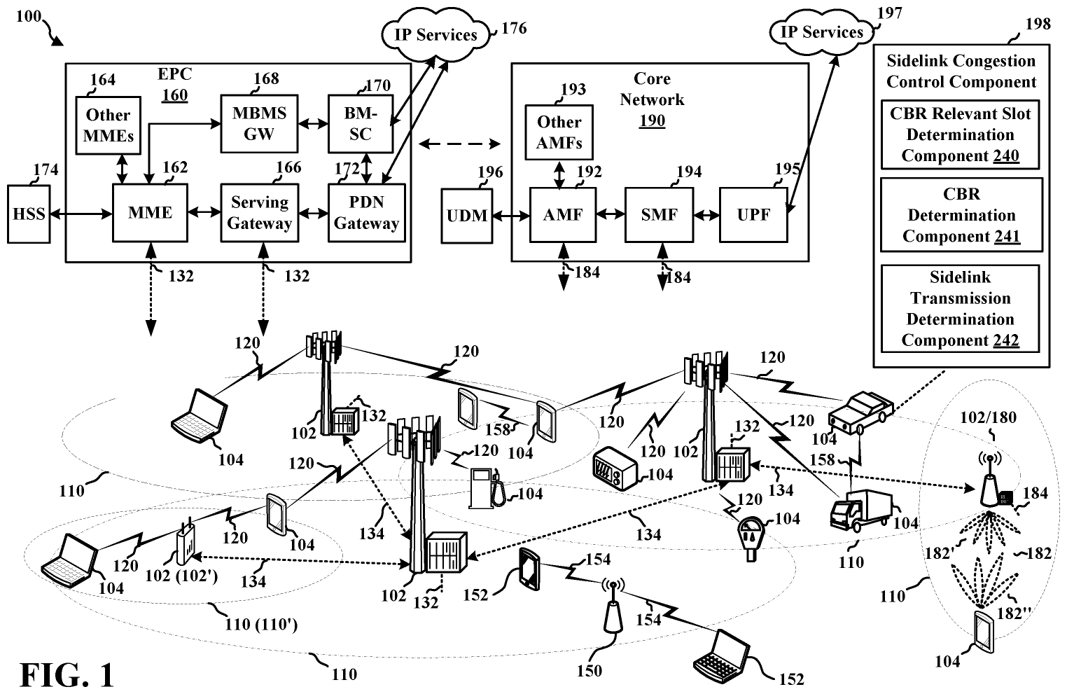

In an optional or additional aspect, the UE may consider only CBR relevant slots for determination of CBR and CR. A CBR relevant slot may be defined as one or any combination of a slot in which sidelink transmission is detected, or a slot included in a sidelink channel occupancy such as a sidelink channel occupancy time (COT), or a slot not occupied by other RATs (e.g., a slot sensed as free from transmission by other RATs). For determining the CBR relevant slots, the UE may implement one or more techniques as described below with reference to FIGS. 1-9.

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)).

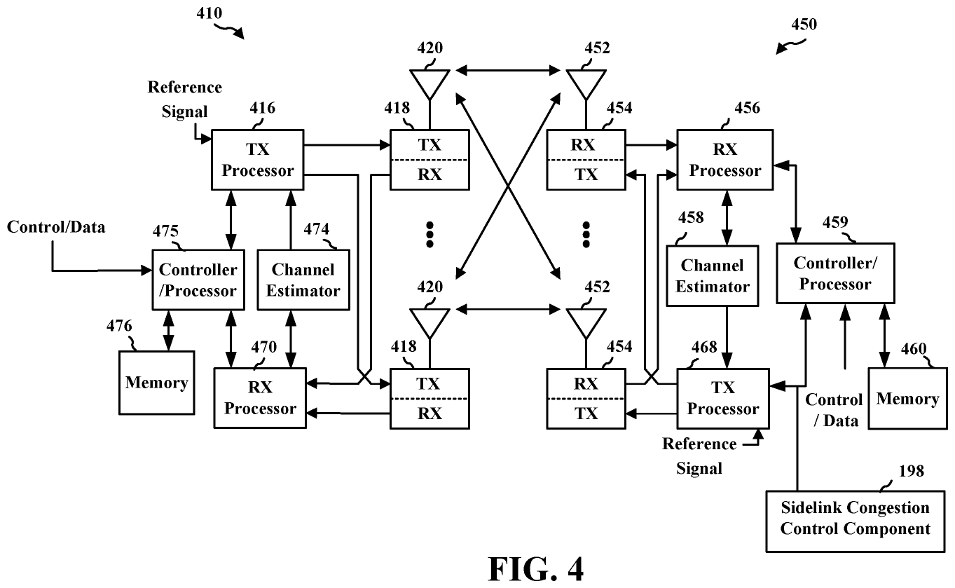

In an aspect, UE 104 may utilize sidelink congestion control component 198 to implement sidelink congestion control and determine whether to transmit a sidelink transmission. The sidelink congestion control component 198 may include a CBR relevant slot determination component 240 for determining CBR relevant slots for determining CBR and CR as described herein. The sidelink congestion control component 198 may include a CBR determination component 241 for determining the CBR in CBR relevant slots. Additionally, the sidelink congestion control component 198 may also include a sidelink transmission determination component 242 for determining whether or not to transmit a sidelink transmission. The details of the sidelink congestion control component 198 are also described below in FIGS. 4-9.

The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5GNR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, and 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a PSSCH, and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

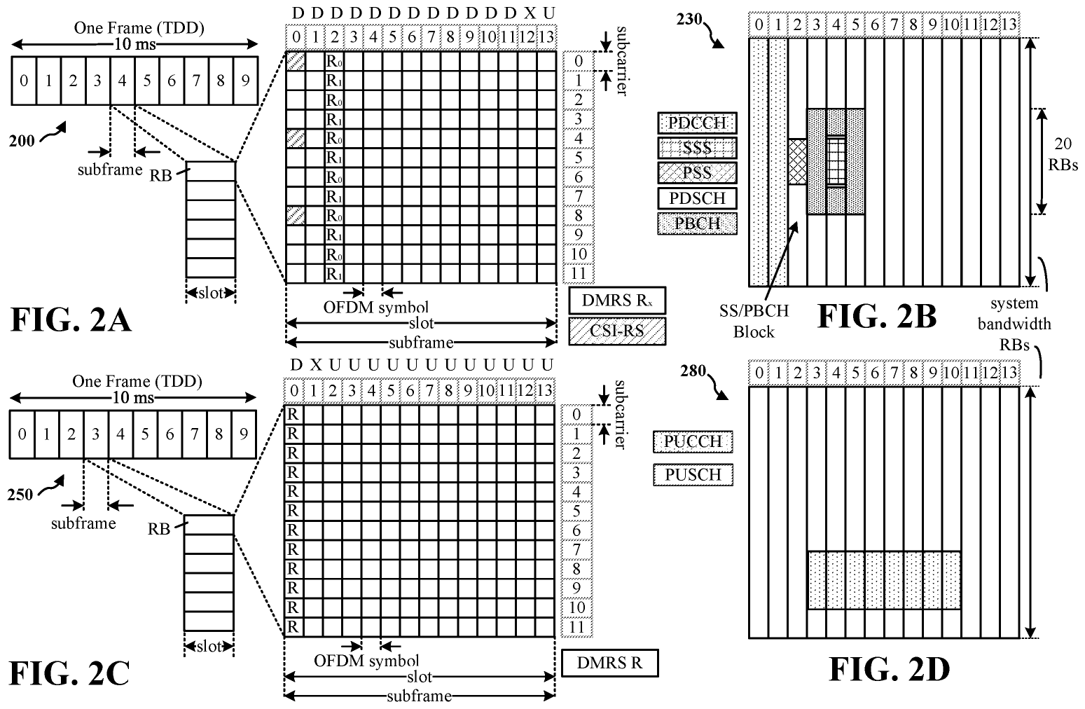

FIGS. 2A-2D include diagrams of example frame structures and resources that may be utilized in communications between the base stations 102, and the UEs 104a/b, described in this disclosure. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

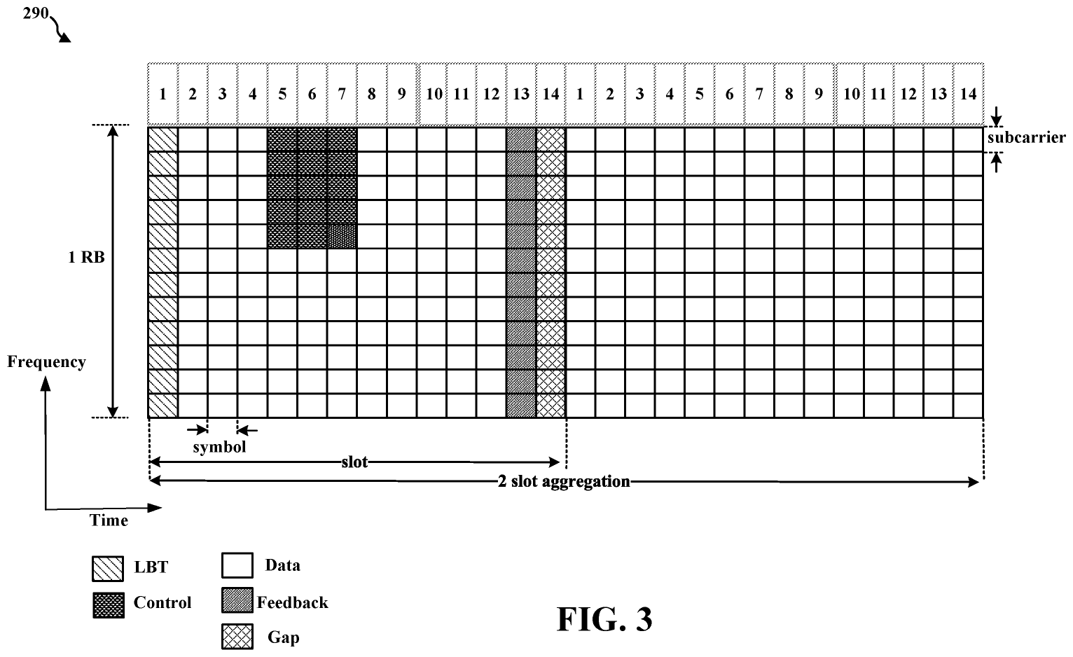

FIG. 3 is a diagram 290 of an example of a slot structure that may be used within a 5G/NR frame structure, e.g., for sidelink communication. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. Some of the REs may comprise control information, e.g., along with demodulation RS (DM-RS). The control information may comprise Sidelink Control Information (SCI). In some aspects, at least one symbol at the beginning of a slot may be used by a transmitting device to perform a Listen Before Talk (LBT) operation prior to transmitting. In some aspects, at least one symbol may be used for feedback, as described herein. In some aspects, another symbol, e.g., at the end of the slot, may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. In some aspects, multiple slots may be aggregated together, and the example aggregation of two slots in FIG. 3 should not be considered limiting, as the aggregated number of slots may also be larger than two. When slots are aggregated, the symbols used for feedback and/or a gap symbol may be different that for a single slot.

FIG. 4 is a block diagram of a base station 410 in communication with a UE 450 in an access network, where the base station 410 may be an example of base station 102 and where UE 450 may be an example of UE 104. In the DL, IP packets from the EPC 160 may be provided to a controller/processor 475. The controller/processor 475 implements layer 4 and layer 2 functionality. Layer 4 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 4 and layer 2 functionality.

The controller/processor 459 can be associated with a memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the base station 410 in a manner similar to that described in connection with the receiver function at the UE 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with the sidelink congestion control component 198 of FIG. 1. For simplification, all the components of the sidelink congestion control component 198 are not shown in FIG. 4.

According to the present aspects, in a first alternative, the CBR relevant slot determination component 240 determines a slot as a CBR relevant slot if a sidelink transmission is detected in the slot. For example, the CBR relevant slot determination component 240 may determine that a sidelink control information (SCI) is successfully decoded in a slot. In one example, the CBR relevant slot determination component 240 may determine that a first stage control (e.g., SCI in PSCCH is decoded). In another example, the CBR relevant slot determination component 240 may determine that a first stage control and second stage control (e.g., SCI in PSSCH is decoded).

In a further aspect, the CBR relevant slot determination component 240 may also determine the slot as a CBR relevant slot when at least one PSSCH transmission is successfully decoded. Further, the CBR relevant slot determination component 240 may determine the slot as a CBR relevant slot when a sidelink-specific signal (such as a sidelink hybrid automatic repeat request (HARQ) feedback transmission, or other sidelink signal such as a sidelink preamble, a sidelink reference signal, etc.) is detected.

In a second alternative, the CBR relevant slot determination component 240 may determine a slot as a CBR relevant slot if the slot is included in a sidelink channel occupancy (sidelink CO or, in some cases, a sidelink channel occupancy time (sidelink COT)). For example, a UE, a BS, or a road side unit (RSU) may initiate a sidelink channel occupancy (or sidelink COT) for sidelink communications. The CBR relevant slot determination component 240 may determine that a slot is in the sidelink CO (or COT), and hence if the slot is a CBR relevant slot, if a signaling decoded in the slot, or a signaling decoded in an earlier slot (e.g., one or more preceding slots to the slot), or a signaling decoded in a later slot (e.g., one or more succeeding slots to the slot) indicate that the slot is a part of the sidelink channel occupancy. In one example, SCI may indicate sidelink channel occupancy related information (e.g., time location indicating starting or ending slot locations, a duration of the sidelink channel occupancy, etc.). The SCI decoded in an earlier slot, or in the current slot, or in a later slot, may be determined to indicate that the current slot is included in sidelink channel occupancy. Based on the indication according to the SCI, the CBR relevant slot determination component 240 may determine and/or count the slot as a CBR relevant slot. Thus, in other words, the CBR relevant slot determination component 240 may determine slots included in a sidelink channel occupancy as CBR relevant slots, regardless of whether sidelink signals have been detected or whether a sidelink transmission is present in the slot.

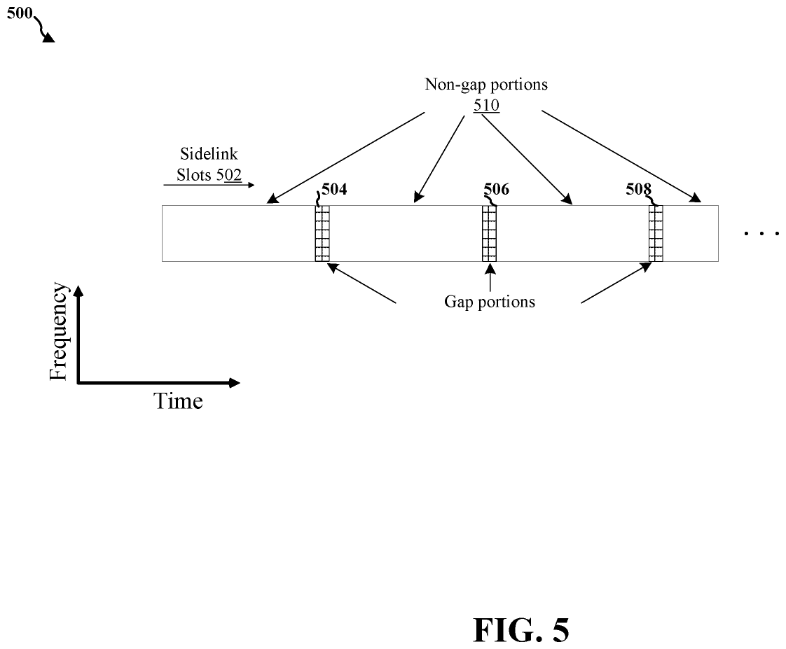

In addition to CBR relevant slots determined in the above first and second alternatives, in a third alternative, the CBR relevant slot determination component 240 may determine unoccupied slots as CBR relevant slots. For example, an unoccupied slot may be a slot that is sensed free of transmissions from other RATs. In one example, the unoccupied slot may be a slot that has no transmissions from sidelink (e.g., no sidelink transmission detected in the slot, and/or the slot does not belong to a sidelink channel occupancy), and the slot has no signals from other RATs (such as, but not limited to, Wi-Fi). Thus, in one example, the CBR relevant slot determination component 240 may determine the relevant slots for CBR measurement to be any one of the following: slots having sidelink signals detected, or slots having no sidelink signals detected but that are sensed as free from transmissions, as CBR relevant slots; or slots belonging to a sidelink channel occupancy, or slots not belonging to a sidelink channel occupancy but that are sensed as free as CBR relevant slots; or, slots that are sensed as free from transmissions from other RATs as CBR relevant slots. Further details of the third alternative are as described below with reference to FIG. 5.

Referring to FIG. 5, the diagram 500 includes sidelink slots 502 with time domain represented along x axis and frequency domain along y axis. The sidelink slots 502 may include one or more gap portions represented by gap portions 504, 506 and 508. The gap portions 504, 506 and 508 may not have any sidelink transmissions. The sidelink slots 502 may include non-gap portion 510 during which the sidelink slots 502 may have sidelink transmissions.

In one example, in accordance with the third alternative as described above, the CBR relevant slot determination component 240 may determine a slot as a CBR relevant slot if sidelink signals are detected in the slot, or the slot belongs to a sidelink channel occupancy; or, if no sidelink signals are detected in the slot but an energy level in the slot is below an energy detection (ED) threshold. The ED threshold may be the same threshold as that used for channel access techniques such as LBT, or a different pre-configured value. In one aspect, the CBR relevant slot determination component 240 may detect an energy in the slot by specifying one or more ED windows within the slot. For example, when multiple ED windows are specified in a slot (e.g., multiple ED windows are (pre-configured or pre-defined), the energy level of the slot may be determined as one of an average energy level of energy levels measured in multiple detection windows, a maximum energy level of the energy levels measured in the multiple detection windows, or a minimum energy level of the energy levels measured in the multiple detection windows. The CBR relevant slot determination component 240 may then compare the energy level of the slot against the ED threshold. The CBR relevant slot determination component 240 may determine the slot as a CBR relevant slot when the energy level in the slot is not above the ED threshold. The CBR relevant slot determination component 240 may determine the slot as not CBR relevant when the energy level in the slot is above the ED threshold.

In one example, the ED window is a time window in one of the gap portions (e.g., gap portions 504, 506 or 508) of the slot. For example, the gap portions 504, 506 and 508 may be system-wide gaps in the sidelink slots 502. Further, the gap portions may not have any sidelink transmissions (e.g., a last OFDM symbol may have a gap portion). For example, if an ED level in the ED window or the gap portions of the slot is below the ED threshold, the CBR relevant slot determination component 240 may determine the slot as a CBR relevant slot, since a transmission(s) from other RATs may not respect sidelink slot format (e.g., if the transmission(s) from other RATs exists, a sidelink UE may detect higher energy in the gap due to the transmission(s) from other RATs being present in the gap).

In another example, the ED window is a time window in one of the non-gap portions (e.g., 510) of the slot. In this case, the CBR relevant slot determination component 240 may perform energy detection out of the gap in order to target energy from other RAT transmissions, since energy sensing is performed only when no sidelink signals or sidelink channel occupancy is detected.

In another example, the CBR relevant slot determination component 240 may utilize RSSI measurements, instead of measuring the energy level in the slot, and compare the measured RSSI in the slot against an RSSI threshold to determine whether the slot is a CBR relevant slot. The RSSI threshold may be the same threshold as used for CBR measurement, or a different threshold (e.g., a higher value). The RSSI threshold may also be a value converted from the ED threshold (e.g., convert a −72 dBm/20 MHz threshold to the corresponding energy level for one subchannel bandwidth or all subchannel bandwidth). The CBR relevant slot determination component 240 may determine the slot as a CBR relevant slot when the measured RSSI in the slot is below the RSSI threshold. The CBR relevant slot determination component 240 may determine the slot as not a CBR relevant slot when the measured RSSI in the slot is above the RSSI threshold. In one example, an RSSI may be the same as SL RSSI measurement for CBR (with each subchannel having a measured SL RSSI). The CBR relevant slot determination component 240 may determine the slot as a CBR relevant slot when one of the minimum, or maximum, or average of the SL RSSI measured across subchannels is below the RSSI threshold. In another example, the RSSI measurement may be a single RSSI measurement (e.g., a linear average of the total received power (in Watts) observed in all configured sub-channels in OFDM symbols of the slot, starting from the second OFDM symbol).

Further, in another example of the third alternative as described above, the CBR relevant slot determination component 240 may determine a slot as a CBR relevant slot if the slot is free from transmissions from other RATs. In other words, whether a slot is taken into account for CBR measurement does not depend on whether a sidelink transmission has been detected or not, but depends on if a slot is occupied by another RAT transmission. For example, the CBR relevant slot determination component 240 may determine the slot as a CBR relevant slot if there is a gap portion (e.g., a recurring gap or a system-wide gap) in the sidelink slot and there is no sidelink signal transmission in the gap. In this case, the CBR relevant slot determination component 240 may determine the slot as a CBR relevant slot if the energy sensed in an ED window in the gap is below the ED threshold. In one example, when there is a gap at the end of each slot, the CBR relevant slot determination component 240 determines the slot as a CBR relevant slot relevant, if an energy level in the ED window in the gap of the slot, and an energy level in an ED window in the gap of the preceding slot, are below the ED threshold. In another example, when there is a gap at the beginning of each slot, the CBR relevant slot determination component 240 determines the slot as a CBR relevant slot if an energy level in an ED window in the gap of the slot, and an energy level in an ED window in the next slot, are below the ED threshold. In another example, when there is a gap in each slot, the CBR relevant slot determination component 240 determines the slot as a CBR relevant slot when an energy level in an ED window in the gap of the slot is below the ED threshold.

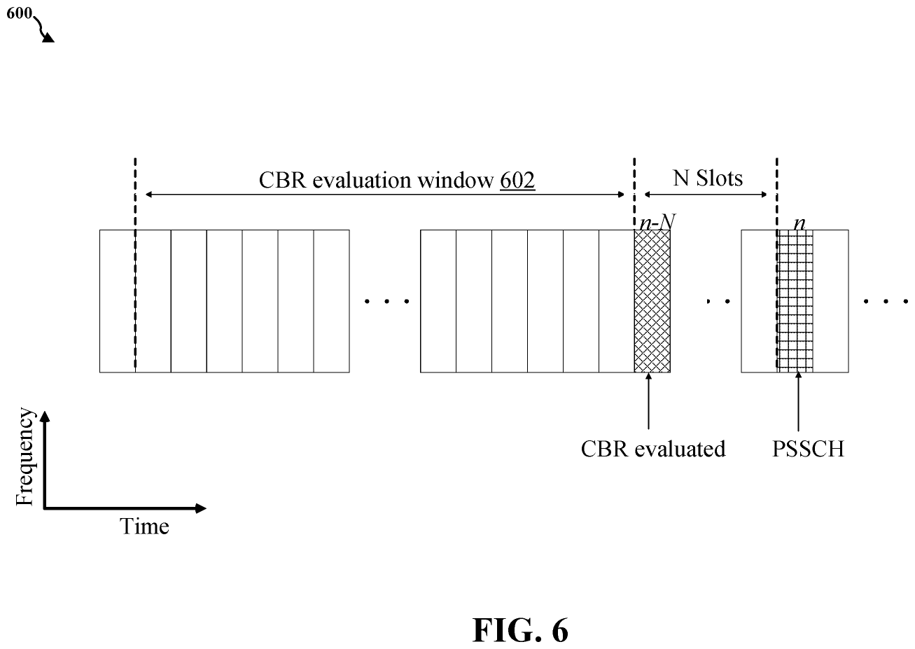

Referring to FIG. 6, the diagram 600 illustrates a CBR evaluation window 602 with frequency domain along the y axis and time domain along the x axis. The CBR determination component 241 (as described above with reference to FIGS. 1-5) determines a CBR in the CBR relevant slots determined by the CBR relevant slot determination component 240. In one aspect, the CBR determination component 241 determines a sidelink (SL) CBR in slot n as a portion of sub-channels in a resource pool (e.g., all available set of resources) whose SL RSSI measured by the CBR relevant slot determination component 240 exceeds the RSSI threshold in a CBR evaluation window 602 (e.g., a window [n−a, n−1], wherein a is equal to 100 or 100×2^{μ} slots). According to a higher layer parameter (e.g., timeWindowSize-CBR), the slot index may be based on a physical slot index, however, only CBR relevant slots (as determined by the CBR relevant slot determination component 240) are considered for CBR measurement by the CBR determination component 241. Therefore, in the CBR evaluation window 602 [n−a, n−1], with only CBR relevant slots being considered, the actual total number of slots that are used for CBR measurement may be less than 100 or 100×2^{μ}).

In another aspect, the CBR determination component 241 determines an SL CBR in slot n as the portion of sub-channels in the resource pool (e.g., all available set of resources) whose SL RSSI measured by the UE exceeds the RSSI threshold sensed over the CBR evaluation window 602 [n−a, n−1], where a is equal to 100 or 100.2 slots. According to a higher layer parameter (e.g., timeWindowSize-CBR), the slot index may be based on a logical slot index, however only CBR relevant slots (as determined by the CBR relevant slot determination component 240) are considered for CBR measurement by the CBR determination component 241. For example, the logical slot index may be used to index the CBR relevant slots. In one example, a CBR measurement may be measured in 100 or 100×2^{μ} CBR relevant slots, and the CBR measurement window may span more than 100 physical slots, as within the CBR window, some slots may not be CBR relevant. In this example CBR may be measured in a CBR measurement window which may have 100 or 100×2^{μ} CBR relevant slots, while the logical slot index may be indexing the CBR relevant slot within the CBR measurement window. Therefore, the CBR determination component 241 may consider 100 or 100×2^{μ} CBR-relevant slots preceding slot n thereby expanding the evaluation window 602 to determine CBR in 100 or 100×2^{μ} slots).

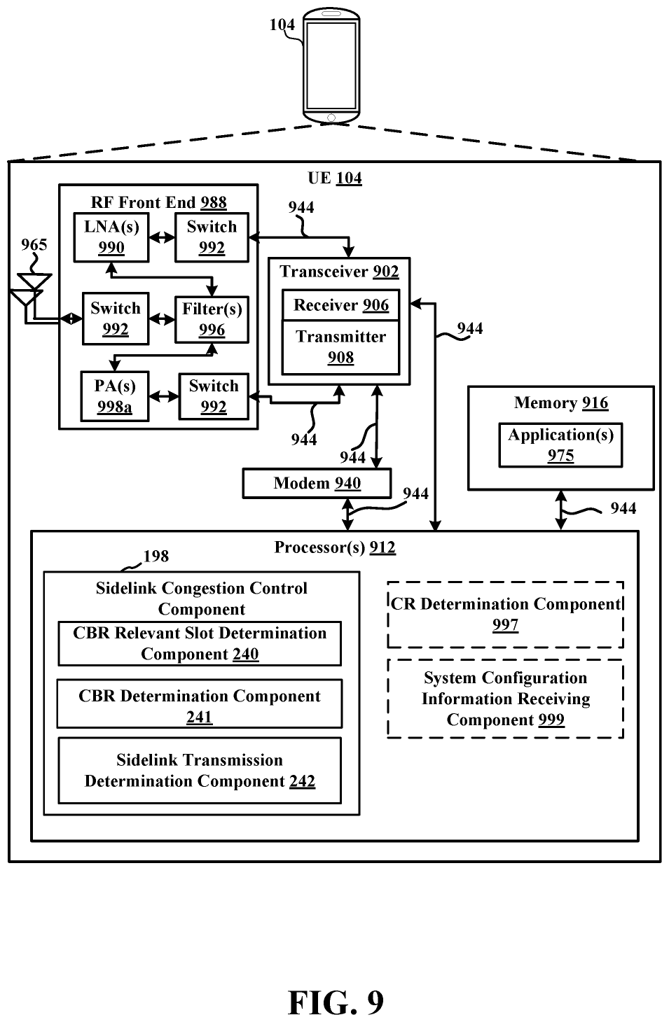

In one aspect, an optional CR determination component 997 (not shown in FIG. 1 for simplification; see FIG. 9) of the UE, may determine a sidelink CR (SL CR) in a CR evaluation window. For example, the CR determination component 997 may determine the SL CR in CBR relevant slots determined by the CBR relevant slot determination component 240. In one example, the CR determination component 997 may determine the SL CR as the a total number of sub-channels used for transmissions in slots [n−a, n−1] and granted in slots [n, n+b] divided by a total number of configured sub-channels in a transmission pool of the CBR relevant slots (as determined by the CBR relevant slot determination component 240) over [n-a, n+b], with a+b+1=1000 or 1000×2^{μ} slots. Therefore, the CR determination component 997 may only utilize CBR relevant slots (e.g., in slots [n−a, n−1] as it may not be possible to determine CBR relevant slots in a future window i.e., [n, n+b]) for the SL CR determination and the total number of slots for SL CR determination may be smaller than 1000 or 1000×2^{μ}.

In another example, the CR determination component 997 may determine the SL CR as the total number of sub-channels used for transmissions in slots [n−a1, n−1] and granted in slots [n, n+b] divided by the total number of configured sub-channels in the transmission pool in the CBR relevant slots (as determined by the CBR relevant slot determination component 240) over [n−a1, n+b], with a1>a and slots [n−a1, n−1] including the CBR relevant slots. Therefore, the CR determination component 997 may be able to utilize CBR relevant slots in slots preceding slot n for the SL CR determination. The CR determination component 997 may determine the SL CR in 1000 or 1000×2^{μ} slots, which may include the latest a CBR relevant slots preceding slot n (in slots [n−a1, n−1]), and b future slots that following slot n.

In one aspect, the CBR relevant slot determination component 240 may determine CBR relevant slots based on one of the three alternatives as described above in FIG. 4 description. In one example, one of the three alternatives may be pre-configured for the CBR relevant slot determination component 240. In another example, a system configuration information receiving component 999 (not shown in FIG. 1 for simplification; see FIG. 9) may receive a CBR relevant slot procedure indicator that may identify a CBR relevant slot procedure as one or a combination of the CBR relevant slot determination techniques as described above. The system configuration information receiving component 999 on receiving the CBR relevant slot procedure indicator may indicate the CBR relevant slot determination component 240 to perform CBR relevant slot determination in accordance with the technique or the combination of techniques specified by the system configuration information receiving component 999.

In one aspect, fractional slots may be considered for CBR and/or CR measurement. In the previous examples, the options for determining a CBR relevant slot are applicable to the case when the channel bandwidth is equal to or greater than a minimum channel bandwidth (e.g., a minimum channel bandwidth specified for sidelink, or a minimum channel bandwidth of other RATs (as specified by regulator)). It is also possible, however, to determine resources for CBR measurement in a finer granularity, such as when the sidelink transmission occupies greater channel bandwidth than a transmission from a RAT other than sidelink communications. For example, Wi-Fi transmissions may have a channel bandwidth of 20 MHz, and sidelink transmissions may be multiple of 20 MHz (e.g., V2X may occupy 40 MHz as channel bandwidth), and the UE 104 may be able to transmit a sidelink transmission in 20 MHz (an RB set), if the other 20 MHz (the other RB set) of the 40 MHz channel bandwidth is occupied by Wi-Fi. In this aspect, the CBR relevant slot determination component 240 may determine a shared slot between the Wi-Fi and sidelink transmissions as a CBR relevant slot, but only subchannels in the sidelink occupied RB set are taken into consideration for CBR measurement. For example, the CBR determination component 241 may count the shared slot as 0.5 (e.g., 20/40) of a CBR relevant slot.

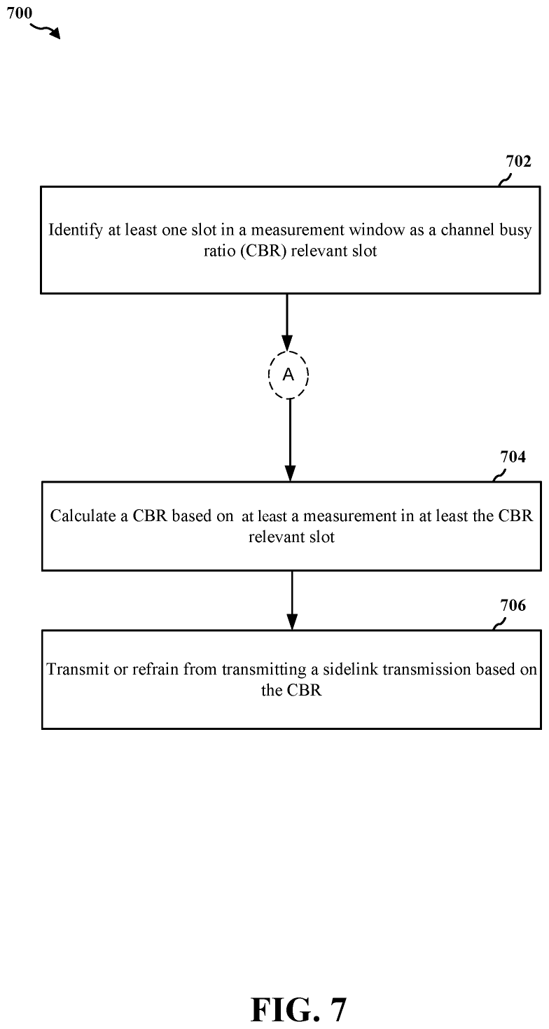

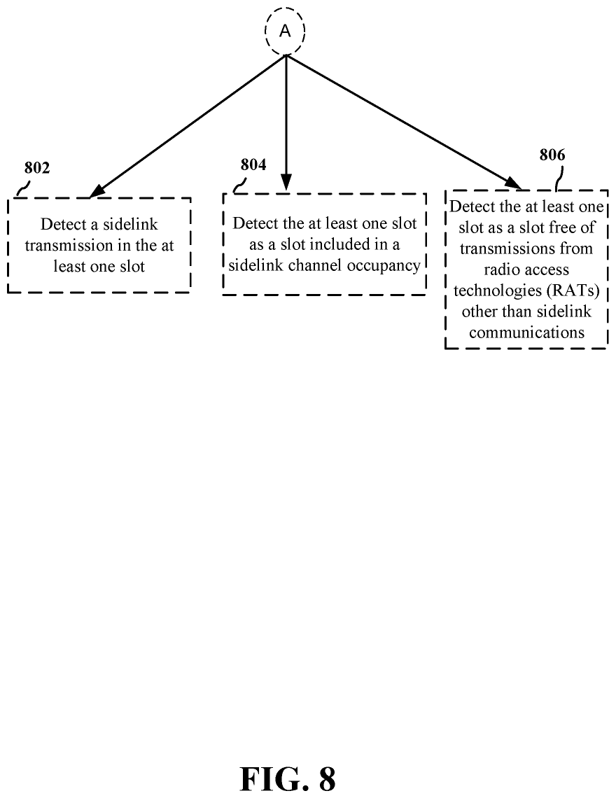

Referring to FIGS. 7-9, an example method 700 of sidelink communication is described with reference to FIGS. 7 and 8, and the method 700 may be performed by the UE 104, which may include one or more components as discussed in FIG. 9. Thus, the following discussion refers to the method 700 of FIGS. 7 and 8 and the corresponding components of FIG. 9 in one example of sidelink congestion control for sidelink transmission by the UE 104.

At 702, method 700 includes determining at least one slot in a measurement window as a CBR relevant slot. For example, in an aspect, UE 104, processor(s) 912, memory 916, modem 940, sidelink congestion control component 198, and/or CBR relevant slot determination component 240 may be configured to or may define means for determining at least one slot in a measurement window as a CBR relevant slot. For example, the determining of the CBR relevant slots is further described in operations at stage A (as described below in FIG. 8) and as described above with reference to FIGS. 1-6.

At 704, method 700 includes calculating a CBR based on at least a measurement in at least the CBR relevant slot. For example, in an aspect, UE 104, processor(s) 912, memory 916, modem 940, sidelink congestion control component 198, and/or CBR determination component 241 may be configured to or may define means for calculating a CBR based on at least a measurement in at least the CBR relevant slot. For example, the SL CBR may be determine as described above with reference to FIGS. 1-6.

At 706, method 700 includes transmitting or refraining from transmitting a sidelink transmission based on the CBR. For example, in an aspect, UE 104, processor(s) 912, memory 916, modem 940, transceiver 902, RF front end 988, antennae 965, sidelink congestion control component 198, and/or the sidelink transmission determination component 242 may be configured to or may define means for transmitting or refraining from transmitting a sidelink transmission based on the CBR. In one example, the sidelink transmission determination component 242 may determine to transmit the sidelink transmission when an SL CR (as described above with reference to FIG. 5 is below a threshold). In another example, the sidelink transmission determination component 242 may determine to refrain from transmitting the sidelink transmission when the SL CR is below the threshold due to congestion on the channel.

Referring to FIG. 8, the optional operations at stage A, as described above with reference to FIG. 7 may be performed by processor(s) 912, memory 916, modem 940, sidelink congestion control component 198, and/or the CBR relevant slot determination component 240 of the UE 104 in conjunction with one or more components of the UE 104 as illustrated in FIG. 9.

At 802, the method 700 optionally includes detecting a sidelink transmission in the at least one slot. For example, in an aspect, processor(s) 912, memory 916, modem 940, sidelink congestion control component 198, and/or the CBR relevant slot determination component 240 may determine the slot as a relevant CBR slot as described above with reference to the first alternative.

At 804, the method 700 optionally includes detecting the at least one slot as a slot included in a sidelink channel occupancy. For example, in an aspect, processor(s) 912, memory 916, modem 940, sidelink congestion control component 198, and/or the CBR relevant slot determination component 240 may operate to determine the slot as a relevant CBR slot as described above with reference to the second alternative.

At 806, the method 700 optionally includes detecting the at least one slot as a slot free of transmissions from RATs other than sidelink communications. For example, in an aspect, processor(s) 912, memory 916, modem 940, sidelink congestion control component 198, and/or the CBR relevant slot determination component 240 may operate to determine the slot as a relevant CBR slot as described above with reference to the third alternative.

Referring to FIG. 9, one example of the UE 104 may include a variety of components, some of which have already been described above and are described further herein, including components such as one or more processors 912 and the memory 916 and a transceiver 902 in communication via one or more buses 944, which may operate in conjunction with a modem 940 and/or the sidelink congestion control component 198 for implementing congestion control for sidelink. The sidelink congestion control component 198 may include the CBR relevant slot determination component 240, the CBR determination component 241, the sidelink transmission determination component 242 (as described above with reference to FIGS. 1-8), the CR determination component 997 (as described above with reference to FIG. 6) and the system configuration information receiving component 999 (as described above with reference to FIG. 6).

In an aspect, the one or more processors 912 can include the modem 940 and/or can be part of the modem 940 that uses one or more modem processors. Thus, the various functions related to sidelink congestion control component 198 may be included in the modem 940 and/or processors 912 and, in an aspect, can be executed by a single processor, while in other aspects, different ones of the functions may be executed by a combination of two or more different processors. For example, in an aspect, the one or more processors 912 may include any one or any combination of a modem processor, or a baseband processor, or a digital signal processor, or a transmit processor, or a receiver processor, or a transceiver processor associated with a transceiver 902. In other aspects, some of the features of the one or more processors 912 and/or the modem 940 associated with the sidelink congestion control component 198 may be performed by the transceiver 902.

Also, the memory 916 may be configured to store data used herein and/or local versions of applications 975 and/or one or more of its subcomponents being executed by at the least one processor 912. The memory 916 can include any type of computer-readable medium usable by a computer or the at least one processor 912, such as random access memory (RAM), read only memory (ROM), tapes, magnetic discs, optical discs, volatile memory, non-volatile memory, and any combination thereof. In an aspect, for example, the memory 916 may be a non-transitory computer-readable storage medium that stores one or more computer-executable codes defining the sidelink congestion control component 198 and/or one or more of its subcomponents, and/or data associated therewith, when the UE 104 is operating the at least one processor 912 to execute the sidelink congestion control component 198 and/or one or more of its subcomponents.

The transceiver 902 may include at least one receiver 906 and at least one transmitter 908. The receiver 906 may include hardware and/or software executable by a processor for receiving data, the code comprising instructions and being stored in a memory (e.g., computer-readable medium). The receiver 906 may be, for example, a radio frequency (RF) receiver. In an aspect, the receiver 906 may receive signals transmitted by at the least one base station 102. Additionally, the receiver 906 may process such received signals, and also may obtain measurements of the signals, such as, but not limited to, Ec/Io, signal-to-noise ratio (SNR), reference signal received power (RSRP), received signal strength indicator (RSSI), etc. The transmitter 908 may include hardware and/or software executable by a processor for transmitting data, the code comprising instructions and being stored in a memory (e.g., computer-readable medium). A suitable example of the transmitter 908 may including, but is not limited to, an RF transmitter.

Moreover, in an aspect, the UE 104 may include the RF front end 988, which may operate in communication with one or more antennas 965 and the transceiver 902 for receiving and transmitting radio transmissions, for example, wireless communications transmitted by at the least one base station 102 or wireless transmissions transmitted by the UE 104. The RF front end 988 may be connected to one or more antennas 965 and can include one or more low-noise amplifiers (LNAs) 990, one or more switches 992, one or more power amplifiers (PAs) 998a, and one or more filters 996 for transmitting and receiving RF signals.

In an aspect, the LNA 990 can amplify a received signal at a desired output level. In an aspect, each the LNA 990 may have a specified minimum and maximum gain values. In an aspect, the RF front end 988 may use one or more switches 992 to select a particular LNA 990 and its specified gain value based on a desired gain value for a particular application.

Further, for example, the one or more PA(s) 998a may be used by the RF front end 988 to amplify a signal for an RF output at a desired output power level. In an aspect, each the PA 998a may have specified minimum and maximum gain values. In an aspect, the RF front end 988 may use the one or more switches 992 to select a particular PA 998a and its specified gain value based on a desired gain value for a particular application.

Also, for example, one or more filters 996 can be used by the RF front end 988 to filter a received signal to obtain an input RF signal. Similarly, in an aspect, for example, a respective filter 996 can be used to filter an output from a respective PA 998a to produce an output signal for transmission. In an aspect, each filter 996 can be connected to a specific LNA 990 and/or PA 998a. In an aspect, the RF front end 988 can use one or more switches 992 to select a transmit or receive path using a specified filter 996, the LNA 990, and/or the PA 998a, based on a configuration as specified by the transceiver 902 and/or the processor 912.

As such, the transceiver 902 may be configured to transmit and receive wireless signals through the one or more antennas 965 via the RF front end 988. In an aspect, transceiver may be tuned to operate at specified frequencies such that the UE 104 can communicate with, for example, the one or more base stations 102 or one or more cells associated with the one or more base stations 102. In an aspect, for example, modem 940 can configure the transceiver 902 to operate at a specified frequency and power level based on the UE configuration of the UE 104 and the communication protocol used by modem 940.

In an aspect, the modem 940 can be a multiband-multimode modem, which can process digital data and communicate with the transceiver 902 such that the digital data is sent and received using the transceiver 902. In an aspect, the modem 940 can be multiband and be configured to support multiple frequency bands for a specific communications protocol. In an aspect, the modem 940 can be multimode and be configured to support multiple operating networks and communications protocols. In an aspect, the modem 940 can control one or more components of UE the 104 (e.g., the RF front end 988, the transceiver 902) to enable transmission and/or reception of signals from the network based on a specified modem configuration. In an aspect, the modem configuration can be based on the mode of the modem and the frequency band in use. In another aspect, the modem configuration can be based on UE configuration information associated with the UE 104 as provided by the network during cell selection and/or cell reselection.

In an aspect, the processor(s) 912 may correspond to one or more of the processors described in connection with the UE in FIG. 4. Similarly, the memory 916 may correspond to the memory described in connection with the UE in FIG. 4.

### Some Further Example Clauses

Additional examples are described in the following numbered clauses:
1. A method of sidelink communications, comprising:
identifying at least one slot in a measurement window as a channel busy ratio (CBR) relevant slot;
calculating a CBR based on at least a measurement in at least the CBR relevant slot; and
transmitting, or refraining from transmitting, a sidelink transmission based at least on the CBR.
2. The method of clause 1, wherein the determining the CBR relevant slot comprises one or a combination of:
detecting a sidelink transmission in the at least one slot;
detecting the at least one slot as a slot included in a sidelink channel occupancy); or
detecting the at least one slot as a slot free of transmissions from radio access technologies (RATs) other than sidelink communications.
3. The method of clause 2, wherein the detecting the sidelink transmission comprises detecting based on one or a combination of:
decoding sidelink control information (SCI) in the slot;
decoding at least one Physical Sidelink Control Channel (PSCCH) transmission; or
detecting at least one sidelink-specific signal.
4. The method of clause 2, wherein the detecting the at least one slot as a slot included in the sidelink channel occupancy comprises detecting based on at least one of
decoding a first signaling in the slot indicating that the slot is a part of the sidelink channel occupancy;
decoding a second signaling in an earlier slot than the slot, the second signaling indicating that the slot included is a part of the sidelink channel occupancy; or
decoding a third signaling in a later slot than the slot, the third signaling indicating that the slot included is a part of the sidelink channel occupancy.
5. The method of any of clauses 2 and 4, wherein the detecting the at least one slot being free of transmissions from RATs other than sidelink communications comprises:
measuring an energy level in an energy detection (ED) window in the slot;
determining whether the energy level is below an ED threshold or above the ED threshold; and
determining the slot being free of transmissions from RATs other than sidelink communications in response to determining that the energy level in the ED window is below the ED threshold.
6. The method of any of clauses 4 and 5, wherein the ED window is a time window in a gap portion of the slot, wherein the gap portion has no sidelink transmissions.
7. The method of any of clauses 4 and 5, wherein the ED window is a time window in a non-gap portion of the slot.
8. The method of any of clauses 2 and 4, wherein the detecting the at least one slot being free of transmissions from RATs other than sidelink communications comprises:
performing a sidelink received signal strength indicator (RSSI) measurement in the slot;
determining whether the sidelink RSSI measurement is below an RSSI threshold or above the RSSI threshold; and
determining the slot being free of transmissions from RATs other than sidelink communications in response to determining that the sidelink RSSI measurement is below the RSSI threshold.
9. The method of any of clauses 2 and 8, wherein the performing the sidelink received signal strength indicator (RSSI) measurement in the slot comprises:
identifying a gap in the slot, wherein the gap is a recurring gap with no sidelink transmissions in the gap; and
determining an absence of a transmission from a RAT other than sidelink communications in the gap.
10. The method of any of clauses 2 and 9, wherein the gap is located at one of:
a beginning of the sidelink slot;
an end of the sidelink slot; or
within the sidelink slot.
11. The method of any of clauses 1-10, wherein the measurement window includes a first number of slots and a second number of CBR relevant slots, and the second number is less than or equal to the first number.
12. The method of any of clauses 1-10, wherein determining the CBR based on the CBR relevant slot comprises the measurement window having a first number of slots, the first number of slots determined based on a second number of CBR relevant slots, wherein the first number is greater than or equal to the second number.
13. The method of any of clauses 1-10, further comprising:
determining, a first set of resources in the CBR relevant slot having a total number of resources in an unlicensed spectrum;
determining, a first number of busy resources in the first set of resources in a channel occupancy ratio (CR) evaluation window; and
determining a CR based at least on the first number of busy resources and the total number of resources in the CBR relevant slot.
14. The method of any of clauses 1-10, wherein the sidelink transmission occupies greater channel bandwidth than a transmission from a radio access technology (RAT) other than sidelink communications, the method further comprising:
determining a shared slot as the CBR relevant slot in subchannels not occupied by the RAT other than sidelink communications, the shared slot being shared among sidelink communications and the RAT other than sidelink communications.
15. The method of clause 2, further comprising:
receiving system configuration information that includes a CBR relevant slot procedure indicator that identifies a CBR relevant slot procedure as one of:
detecting the sidelink transmission in the at least one slot;
detecting the at least one slot as the slot included in the sidelink channel occupancy; or
detecting the at least one slot as the slot free of transmissions from the RATs other than sidelink communications; and
   wherein the determining the CBR relevant slot comprises determining according to the CBR relevant slot procedure identified by the CBR relevant slot procedure indicator.
16. An apparatus for sidelink communication, comprising:
a memory configured to store instructions; and
one or more processors communicatively coupled with the memory, wherein the one or more processors are configured to:
   identify at least one slot in a measurement window as a channel busy ratio (CBR) relevant slot;
   calculate a CBR based on at least a measurement in at least the CBR relevant slot; and
   transmit, or refrain from transmitting, a sidelink transmission based at least on the CBR.
17. The apparatus of clause 16, wherein to determine the CBR relevant slot, the one or more processors are configured to:
detect a sidelink transmission in the at least one slot;
detect the at least one slot as a slot included in a sidelink channel occupancy; or
detect the at least one slot as a slot free of transmissions from radio access technologies (RATs) other than sidelink communications.
18. The apparatus of clause 17, wherein to detect the sidelink transmission, the one or more processors are configured to detect based on at least one of:
decoding sidelink control information (SCI) in the slot;
decoding at least one Physical Sidelink Control Channel (PSCCH) transmission; or
detecting at least one sidelink-specific signal.
19. The apparatus of clause 17, wherein to detect the at least one slot as a slot included in the sidelink channel occupancy, the one or more processors are configured to detect based on at least one of:
decoding a first signaling in the slot indicating that the slot is a part of the sidelink channel occupancy;
decoding a second signaling in an earlier slot than the slot, the second signaling indicating that the slot included is a part of the sidelink channel occupancy; or decoding a third signaling in a later slot than the slot, the third signaling indicating that the slot included is a part of the sidelink channel occupancy.
20. The apparatus of clauses 17 and 19, wherein to detect the at least one slot as being free of transmissions from RATs other than sidelink communications, the one or more processors are configured to:
measure an energy level in an energy detection (ED) window in the slot;
determining whether the energy level is below an ED threshold or above the ED threshold; and
determine the slot being free of transmissions from RATs other than sidelink communications in response to determining that the energy level in the ED window is below the ED threshold.
21. The apparatus of any of clauses 19 and 20, wherein the ED window is a time window in a gap portion of the slot, and the gap portion has no sidelink transmissions.
22. The apparatus of any of clauses 19 and 20, wherein the ED window is a time window in a non-gap portion of the slot.
23. The apparatus of any of clauses 17 and 19, wherein to detect the at least one slot being free of transmissions from RATs other than sidelink communications, the one or more processors are configured to:
perform a sidelink received signal strength indicator (RSSI) measurement in the slot;
determine whether the sidelink RSSI measurement is below an RSSI threshold or above the RSSI threshold; and
determine the slot being free of transmissions from RATs other than sidelink communications in response to determining that the sidelink RSSI measurement is below the RSSI threshold.
24. The apparatus of any of clauses 17 and 23, wherein to perform the sidelink RSSI measurement in the slot, the one or more processors are configured to:
identify a gap in the slot, wherein the gap is a recurring gap with no sidelink transmissions in the gap; and
determine an absence of a transmission from a RAT other than sidelink communications in the gap.
25. The apparatus of any of clauses 17 and 24, wherein the gap is located at one of:
a beginning of the sidelink slot;
an end of the sidelink slot; or
within the sidelink slot.
26. The apparatus of any of clauses 1-10, wherein the measurement window includes a first number of slots and a second number of CBR relevant slots, and the second number is less than or equal to the first number.
27. The apparatus of any of clauses 1-10, wherein the measurement window includes a first number of slots, and wherein the first number of slots determined based on a second number of CBR relevant slots, and the first number is greater than or equal to the second number.
28. The apparatus of any of clauses 1-10, wherein the one or more processors are further configured to:
determine a first set of resources in the CBR relevant slot having a total number of resources in an unlicensed spectrum;
determine a first number of busy resources in the first set of resources in a channel occupancy ratio (CR) evaluation window; and
determine a CR based at least on the first number of busy resources and the total number of resources in the CBR relevant slot.
29. The apparatus of any of clauses 1-10, wherein the sidelink transmission occupies greater channel bandwidth than a transmission from a radio access technology (RAT) other than sidelink communications, and the one or more processors are further configured to:
determine a shared slot as the CBR relevant slot in subchannels not occupied by the RAT other than sidelink communications, the shared slot being shared among sidelink communications and the RAT other than sidelink communications.
30. The apparatus of clause 17, wherein the one or more processors are further configured to:
receive system configuration information that includes a CBR relevant slot procedure indicator that identifies a CBR relevant slot procedure as one of:
   detect the sidelink transmission in the at least one slot;
   detect the at least one slot as the slot included in the sidelink channel occupancy; or
   detect the at least one slot as the slot free of transmissions from the RATs other than sidelink communications; and
      wherein the determine the CBR relevant slot comprises the processor configured to determine according to the CBR relevant slot procedure identified by the CBR relevant slot procedure indicator.

31. An apparatus for wireless communication, comprising means for performing the method of any of clauses 1-15.

32. A non-transitory computer-readable medium storing computer executable code, the code when executed by a processor causes the processor to perform the method of any of clauses 1-15.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of sidelink communications, comprising:
identifying at least one slot in a measurement window as a channel busy ratio (CBR) relevant slot;
calculating a CBR based on at least a measurement in at least the CBR relevant slot; and
transmitting, or refraining from transmitting, a sidelink transmission based at least on the CBR.

2. The method of claim 1, wherein the determining the CBR relevant slot, comprises one or a combination of:
detecting a sidelink transmission in the at least one slot;
detecting the at least one slot as a slot included in a sidelink channel occupancy; or
detecting the at least one slot as a slot free of transmissions from radio access technologies (RATs) other than sidelink communications.

3. The method of claim 2, wherein the detecting the sidelink transmission, comprises detecting based on one or a combination of:
decoding sidelink control information (SCI) in the slot;
decoding at least one Physical Sidelink Control Channel (PSCCH) transmission; or
detecting at least one sidelink-specific signal.

4. The method of claim 2, wherein the detecting the at least one slot as a slot included in the sidelink channel occupancy, comprises detecting based on at least one of:
decoding a first signaling in the slot indicating that the slot is a part of the sidelink channel occupancy;
decoding a second signaling in an earlier slot than the slot, the second signaling indicating that the slot included is a part of the sidelink channel occupancy; or
decoding a third signaling in a later slot than the slot, the third signaling indicating that the slot included is a part of the sidelink channel occupancy.

5. The method of claim 2, wherein the detecting the at least one slot being free of transmissions from RATs other than sidelink communications comprises:
measuring an energy level in an energy detection (ED) window in the slot;
determining whether the energy level is below an ED threshold or above the ED threshold; and
determining the slot being free of transmissions from RATs other than sidelink communications in response to determining that the energy level in the ED window is below the ED threshold.

6. The method of claim 5, wherein the ED window is a time window in a gap portion of the slot, wherein the gap portion has no sidelink transmissions.

7. The method of claim 5, wherein the ED window is a time window in a non-gap portion of the slot.

8. The method of claim 2, wherein the detecting the at least one slot being free of transmissions from RATs other than sidelink communications, comprises:
performing a sidelink received signal strength indicator (RSSI) measurement in the slot;
determining whether the sidelink RSSI measurement is below an RSSI threshold or above the RSSI threshold; and
determining the slot being free of transmissions from RATs other than sidelink communications in response to determining that the sidelink RSSI measurement is below the RSSI threshold.

9. The method of claim 8, wherein the performing the sidelink received signal strength indicator (RSSI) measurement in the slot, comprises:
identifying a gap in the slot, wherein the gap is a recurring gap with no sidelink transmissions in the gap; and
determining an absence of a transmission from a RAT other than sidelink communications in the gap.

10. The method of claim 9, wherein the gap is located at one of:
a beginning of the sidelink slot;
an end of the sidelink slot; or
within the sidelink slot.

11. The method of claim 1, wherein the measurement window includes a first number of slots and a second number of CBR relevant slots, and the second number is less than or equal to the first number.

12. The method of claim 1, wherein measurement window includes a first number of slots, and wherein the first number of slots determined based on a second number of CBR relevant slots, and the first number is greater than or equal to the second number.

13. The method of claim 1, further comprising:
determining a first set of resources in the CBR relevant slot having a total number of resources in an unlicensed spectrum;
determining a first number of busy resources in the first set of resources in a channel occupancy ratio (CR) evaluation window; and
determining a CR based at least on the first number of busy resources and the total number of resources in the CBR relevant slot.

14. The method of claim 1, wherein the sidelink transmission occupies greater channel bandwidth than a transmission from a radio access technology (RAT) other than sidelink communications, the method further comprising:
determining a shared slot as the CBR relevant slot in subchannels not occupied by the RAT other than sidelink communications, the shared slot being shared among sidelink communications and the RAT other than sidelink communications.

15. The method of claim 2, further comprising:
receiving system configuration information that includes a CBR relevant slot procedure indicator that identifies a CBR relevant slot procedure as one of:
detecting the sidelink transmission in the at least one slot;
detecting the at least one slot as the slot included in the sidelink channel occupancy; or
detecting the at least one slot as the slot free of transmissions from the RATs other than sidelink communications; and
wherein the determining the CBR relevant slot comprises determining according to the CBR relevant slot procedure identified by the CBR relevant slot procedure indicator.

16. An apparatus for sidelink communication, comprising:
a memory configured to store instructions; and
one or more processors communicatively coupled with the memory, wherein the one or more processors are configured to:
identify at least one slot in a measurement window as a channel busy ratio (CBR) relevant slot;
calculate a CBR based on at least a measurement in at least the CBR relevant slot; and
transmit, or refrain from transmitting, a sidelink transmission based at least on the CBR.

17. The apparatus of claim 16, wherein to determine the CBR relevant slot, the one or more processors are configured to:
detect a sidelink transmission in the at least one slot;
detect the at least one slot as a slot included in a sidelink channel occupancy; or
detect the at least one slot as a slot free of transmissions from radio access technologies (RATs) other than sidelink communications.

18. The apparatus of claim 17, wherein to detect the sidelink transmission, the one or more processors are configured to detect based on one or a combination of:
decoding sidelink control information (SCI) in the slot;
decoding at least one Physical Sidelink Control Channel (PSCCH) transmission; and/or
detecting at least one sidelink-specific signal.

19. The apparatus of claim 17, wherein to detect the at least one slot as a slot included in the sidelink channel occupancy, the one or more processors are configured to detect based on at least one of:
decoding a first signaling in the slot indicating that the slot is a part of the sidelink channel occupancy;
decoding a second signaling in an earlier slot than the slot, the second signaling indicating that the slot included is a part of the sidelink channel occupancy; or
decoding a third signaling in a later slot than the slot, the third signaling indicating that the slot included is a part of the sidelink channel occupancy.

20. The apparatus of claim 17, wherein to detect the at least one slot as being free of transmissions from RATs other than sidelink communications, the one or more processors are configured to:
measure an energy level in an energy detection (ED) window in the slot;
determining whether the energy level is below an ED threshold or above the ED threshold; and
determine the slot being free of transmissions from RATs other than sidelink communications in response to determining that the energy level in the ED window is below the ED threshold.

21. The apparatus of claim 20, wherein the ED window is a time window in a gap portion of the slot, and the gap portion has no sidelink transmissions.

22. The apparatus of claim 20, wherein the ED window is a time window in a non-gap portion of the slot.

23. The apparatus of claim 17, wherein to detect the at least one slot being free of transmissions from RATs other than sidelink communications, the one or more processors are configured to:
perform a sidelink received signal strength indicator (RSSI) measurement in the slot;
determine whether the sidelink RSSI measurement is below an RSSI threshold or above the RSSI threshold; and
determine the slot being free of transmissions from RATs other than sidelink communications in response to determining that the sidelink RSSI measurement is below the RSSI threshold.

24. The apparatus of claim 23, wherein to perform the sidelink RSSI measurement in the slot, the one or more processors are configured to:
identify a gap in the slot, wherein the gap is a recurring gap with no sidelink transmissions in the gap; and
determine an absence of a transmission from a RAT other than sidelink communications in the gap.

25. The apparatus of claim 16, wherein the measurement window includes a first number of slots and a second number of CBR relevant slots, and the second number is less than or equal to the first number.

26. The apparatus of claim 16, wherein the measurement window includes a first number of slots, and wherein the first number of slots determined based on a second number of CBR relevant slots, and the first number is greater than or equal to the second number.

27. The apparatus of claim 16, wherein the one or more processors are further configured to:
determine a first set of resources in the CBR relevant slot having a total number of resources in an unlicensed spectrum;
determine a first number of busy resources in the first set of resources in a channel occupancy ratio (CR) evaluation window; and
determine a CR based at least on the first number of busy resources and the total number of resources in the CBR relevant slot.

28. The apparatus of claim 16, wherein the sidelink transmission occupies greater channel bandwidth than a transmission from a radio access technology (RAT) other than sidelink communications, and the one or more processors are further configured to:
determine a shared slot as the CBR relevant slot in subchannels not occupied by the RAT other than sidelink communications, the shared slot being shared among sidelink communications and the RAT other than sidelink communications.

29. A non-transitory computer readable medium storing instructions, executable by a processor, for wireless communications, comprising instructions for:
identifying at least one slot in a measurement window as a channel busy ratio (CBR) relevant slot;
calculating a CBR based on at least a measurement in at least the CBR relevant slot; and
transmitting, or refraining from transmitting, a sidelink transmission based at least on the CBR.

30. An apparatus for sidelink communication, comprising:
means for identifying at least one slot in a measurement window as a channel busy ratio (CBR) relevant slot;
means for calculating a CBR based on at least a measurement in at least the CBR relevant slot; and
means for transmitting, or refraining from transmitting, a sidelink transmission based at least on the CBR.
